(19) United States
(12) Patent Application Publication
(10) Pub. No.: US 2012/0106416 A1
(43) Pub. Date: May 3, 2012

(54) SYNCHRONIZATION RECOVERY AFTER LOSS OF SIGNALS FOR WIRELESS NETWORKS

(75) Inventors: Haihong Zheng, Coppell, TX (US); Shashikant Maheshwari, Irving, TX (US)

(73) Assignee: NOKIA SIEMENS NETWORKS OY, Espoo (FI)

(21) Appl. No.: 13/263,299

(22) PCT Filed: Mar. 31, 2010
(86) PCT No.: PCT/EP10/54357

§ 371 Date: Jan. 3, 2012

Related U.S. Application Data
(60) Provisional application No. 61/167,142, filed on Apr. 6, 2009.

(51) Int. Cl. H04W 52/02

(52) U.S. Cl. 370/311

(57) ABSTRACT

Various example embodiments are disclosed. According to an example embodiment, a technique may include determining, by a mobile station, if either a traffic indication or data has been received at the mobile station from a base station during a listening window of a current sleep cycle; and increasing the size of a next sleep cycle, up to a maximum sleep cycle size, if neither the traffic indication nor the data are received during the listening window of the current sleep cycle.

### CROSS-REFERENCE TO RELATED APPLICATIONS

This Application is a national stage entry of International Application No. PCT/EP2010/054357, filed on Mar. 31, 2010, which claims priority based on U.S. Provisional Application No. 61/167,142, filed on Apr. 6, 2009, the disclosures of both of which are hereby incorporated by reference.

### TECHNICAL FIELD

This description relates to wireless networks.

### BACKGROUND

In some wireless networks, mobile stations (or subscriber stations) may occasionally switch to a low power or sleep mode. For example, a mobile station (MS) may negotiate with a base station (BS) to temporarily disrupt one or more wireless connections between the MS and the BS for a period of time known as a sleep window (which may last one or more frames, for example). During the sleep window, the BS does not schedule any downlink (DL) transmissions to the MS and the MS does not send any uplink (UL) transmissions to the BS, so that the MS may power down one or more hardware components required for communication in order to conserve power during the sleep window. For example, during a sleep window for a MS, the BS may buffer or drop arriving unicast packets associated with the MS (or associated with the MS's connection ID or user ID or MS ID), and may buffer any multicast packets for multicast transmission associated with a multicast ID for which the sleeping MS is a member. Each sleep window may typically be followed by a listening window in which the MS returns power to its required hardware components for communication and restores its one or more connections with the BS. During the listening window, any data buffered by the BS for the MS may then be transmitted to the MS and the MS may transmit UL to the BS. The MS may alternate between sleep and listening windows. A sleep cycle may include a listening window followed by a sleep window.

### SUMMARY

According to an example embodiment, a method may include determining, by a mobile station, if either a traffic indication or data has been received at the mobile station from a base station during a listening window of a current sleep cycle and increasing the size of a next sleep cycle, up to a maximum sleep cycle size, if neither the traffic indication nor the data are received during the listening window of the current sleep cycle.

According to another example embodiment, an apparatus may include a processor configured to determine, by a mobile station, if either a traffic indication or data has been received at the mobile station from a base station during a listening window of a current sleep cycle, and increase the size of a next sleep cycle, up to a maximum sleep cycle size, if neither the traffic indication nor the data are received during the listening window of the current sleep cycle.

According to another example embodiment, a method may include transmitting, from a base station, a positive traffic indication and data for a mobile station during a listening window of the current sleep cycle, determining whether or not an acknowledgement or uplink data has been received at the base station from the mobile station during a listening window of a current sleep cycle, and increasing the size of a next sleep cycle, up to a maximum sleep cycle size, if neither the acknowledgement nor the uplink data was received at the base station.

According to another example embodiment, an apparatus may include a wireless transceiver configured to transmit, from a base station, a positive traffic indication and data for a mobile station during a listening window of the current sleep cycle; a processor configured to determine whether or not an acknowledgement or uplink data has been received at the base station from the mobile station during a listening window of a current sleep cycle; and, the processor being further configured to increase the size of a next sleep cycle, up to a maximum sleep cycle size, if neither the acknowledgement nor the uplink data was received at the base station.

According to another example embodiment, a method may include determining, by a mobile station, if either a traffic indication or data has been received at the mobile station from a base station during a listening window of a current sleep cycle; and resetting a size of the current sleep cycle and a next sleep cycle to an initial sleep cycle size if neither the traffic indication nor the data was received during the listening window of the current sleep cycle.

An apparatus may include a processor, the processor configured to: determine, by a mobile station, if either a traffic indication or data has been received at the mobile station from a base station during a listening window of a current sleep cycle; and reset a size of the current sleep cycle and a next sleep cycle to an initial sleep cycle size if neither the traffic indication nor the data was received during the listening window of the current sleep cycle.

According to another example embodiment, a method may include determining, by a mobile station, if either a traffic indication or data has been received at a mobile station from a base station during a listening window of a current sleep cycle, increasing the size of the current sleep cycle if neither the traffic indication nor the data was received during the listening window of the current sleep cycle, and resetting a size of the current sleep cycle and the next sleep cycle to an initial sleep cycle size when a positive traffic indication or data is received from the base station.

According to an example embodiment, an apparatus may include a processor configured to: determine, by a mobile station, if either a traffic indication or data has been received at a mobile station from a base station during a listening window of a current sleep cycle; increase the size of the current sleep cycle if neither the traffic indication nor the data was received during the listening window of the current sleep cycle; and, reset a size of the current sleep cycle and the next sleep cycle to an initial sleep cycle size when a positive traffic indication or data is received from the base station.

In another example embodiment, a method may include transmitting, from a base station, a positive traffic indication and/or data for a mobile station during a listening window of the current sleep cycle, determining whether or not an acknowledgement or uplink data from the mobile station has been received at the base station for the data during a listening window of the current sleep cycle, and resetting a size of a next sleep cycle to an initial sleep cycle size if neither the acknowledgement nor the uplink data was received by the base station during the listening window of the current sleep cycle.

According to another example embodiment, an apparatus may include a wireless transceiver configured to transmit, from a base station, a positive traffic indication and/or data for a mobile station during a listening window of the current sleep cycle, a processor configured to determine whether or not an acknowledgement or uplink data from the mobile station has been received at the base station for the data during a listening window of the current sleep cycle, and the processor further configured to reset a size of a next sleep cycle to an initial sleep cycle size if neither the acknowledgement nor the uplink data was received by the base station during the listening window of the current sleep cycle.

According to another example embodiment, a method may include transmitting, from a base station, a negative traffic indication for a mobile station during a listening window of the current sleep cycle, determining whether or not uplink data or other traffic from the mobile station has been received at the base station, and increasing the size of a next sleep cycle, up to a maximum sleep cycle size, if the uplink data or other traffic was not received at the base station.

In another example embodiment, an apparatus may include a wireless transceiver configured to transmit, from a base station, a negative traffic indication for a mobile station during a listening window of the current sleep cycle, a processor configured to determine whether or uplink data or other traffic from the mobile station has been received at the base station, and wherein the processor is further configured to increase (e.g., double) the size of a next sleep cycle, up to a maximum sleep cycle size, if the uplink data or other traffic was not received at the base station.

According to another example embodiment, a method may include determining, by a mobile station, that a traffic indication has not been received at the mobile station from a base station during a listening window of a current sleep cycle, and sending, from the mobile station to the base station, a signal indicating a failure to receive the traffic indication without de-activating the sleep mode.

According to an example embodiment, an apparatus may include a processor configured to determine, by a mobile station, that a traffic indication has not been received at the mobile station from a base station during a listening window of a current sleep cycle, and a transceiver configured to send or transmit, from the mobile station to the base station, a signal indicating a failure to receive the traffic indication without deactivating the sleep mode.

In another example embodiment, a method may include transmitting a traffic indication from a base station to a mobile station, and receiving, at the base station from the mobile station, a signal indicating a failure of the mobile station to receive the traffic indication.

According to another example embodiment, an apparatus may include a wireless transceiver configured to transmit a traffic indication from a base station to a mobile station, and receive, at the base station from the mobile station, a signal indicating a failure of the mobile station to receive the traffic indication.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2 is a diagram illustrating a frame structure according to an example embodiment.

FIG. 3 is a block diagram illustrating operation of a mobile station according to an example embodiment.

FIG. 4A is a diagram illustrating operation in which a traffic indication and data are transmitted by a base station but not received by a mobile station according to an example embodiment.

FIG. 4B is a diagram illustrating operation where a traffic indication and data are transmitted by a base station but the traffic indication is not received by a mobile station according to an example embodiment.

FIG. 4C is a diagram illustrating operation where a negative traffic indication is transmitted by a base station but not received by the mobile station.

FIG. 5A is a diagram illustrating operation where a traffic indication and data are transmitted but not received by a mobile station and a listening window of the current sleep cycle is extended according to an example embodiment.

FIG. 5B is a diagram illustrating operation in which data retransmitted within an extended listening window is received by a mobile station according to an example embodiment.

FIG. 5C is a diagram illustrating operation where a traffic indication is transmitted and not received and data is transmitted and received by a mobile station according to an example embodiment.

FIG. 5D is a diagram illustrating operation where a negative traffic indication is transmitted but not received by a mobile station according to an example embodiment.

FIG. 6A is a diagram illustrating operation where a mobile station may increase a size of a next sleep cycle if the mobile station does not receive a traffic indication or data during a listening window of the current sleep cycle according to an example embodiment.

FIG. 6B is a diagram illustrating operation in which a size of a current sleep cycle and next sleep cycle may be reset to an initial sleep cycle size based on receipt of data at the MS during a listening window of the current sleep cycle.

FIG. 6C is a diagram illustrating operation in which a negative traffic indication is transmitted by a base station but not received by a mobile station.

FIG. 7A is a diagram illustrating operation where a mobile station may transmit a signal to a base station indicating a failure of the mobile station to receive a traffic indication.

FIG. 7B is a diagram illustrating operation where a traffic indication is lost and data is received at a mobile station according to an example embodiment.

FIG. 7C is a diagram illustrating operation in which a negative traffic indication is lost according to an example embodiment.

FIG. 8 is a flow chart illustrating operation of a mobile station according to an example embodiment.

FIG. 9 is a flow chart illustrating operation of a base station according to an example embodiment.

FIG. 10 is a flow chart illustrating operation of a mobile station according to an example embodiment.

FIG. 11 is a flow chart illustrating operation of a mobile station according to an example embodiment.

FIG. 12 is a flow chart illustrating operation of a base station according to an example embodiment.

FIG. 13 is a flow chart illustrating operation of a base station according to an example embodiment.

FIG. 14 is a flow chart illustrating operation of a mobile station according to an example embodiment.

FIG. 15 is a flow chart illustrating operation of a base station according to an example embodiment.

FIG. 16 is a block diagram of a wireless node according to an example embodiment.

### DETAILED DESCRIPTION

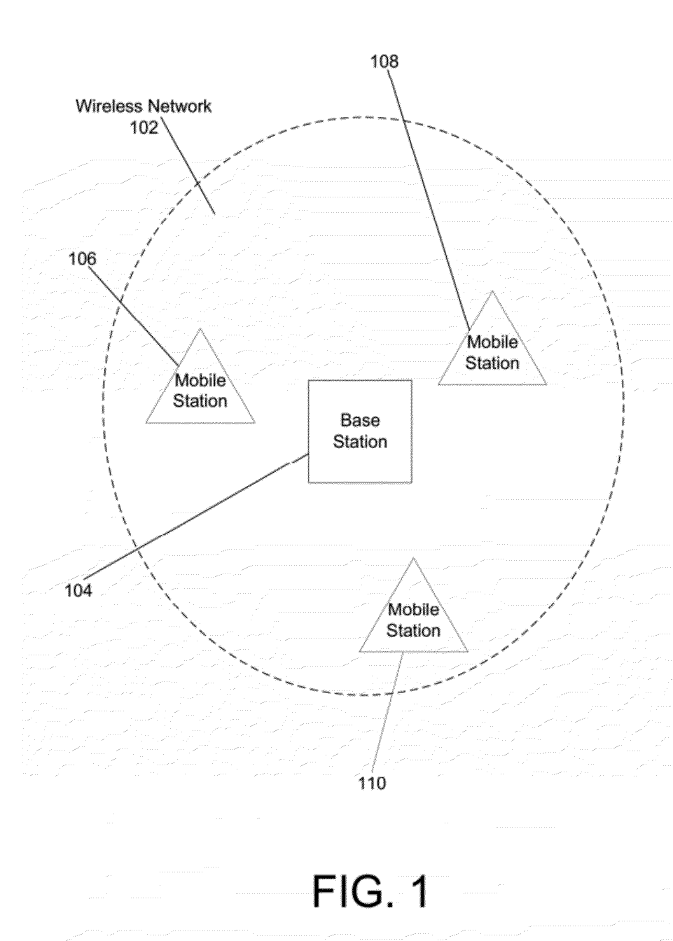

FIG. 1 is a block diagram of a wireless network 102 including a base station 104 and three mobile stations 106, 108, 110 according to an example embodiment. While only three mobile stations are shown, any number may be provided. Although not shown, mobile stations 106, 108 and 110 may be coupled to base station 104 via relay stations or relay nodes, for example. The wireless network 102 may include, for example, an IEEE 802.16 Worldwide interoperability for Microwave Access (WiMAX) network, an IEEE 802.11 Wireless Local Area Network (WLAN) network, a cellular telephone network, or other wireless network, according to example embodiments. The base station 104 may include a cellular or WiMAX base station (BS), a node B, an 802.11 access point, or other infrastructure node, according to various example embodiments. The term “base station” (BS) may be used herein and may include any type of infrastructure node. The mobile stations 106, 108, 110 may include laptop or notebook computers, smartphones, personal digital assistants (PDAs), cellular telephones, WiMAX device, subscriber station, or any other wireless device, according to example embodiments. The term “wireless node” (or “wireless station”) may include any type of wireless node, such as base stations, mobile stations, relay stations, etc. While the present disclosure may use some of the terminology of WiMAX or other wireless standards or specifications, the present disclosure may be applicable to any networking or wireless technologies. Base station (BS) 104 may transmit information (e.g., either broadcast, multicast or unicast) in a downlink (DL) direction to each mobile station (MS) 106, 108, 110, and each MS 106, 108, 110 may transmit information to the BS 104 in an uplink (UL) direction.

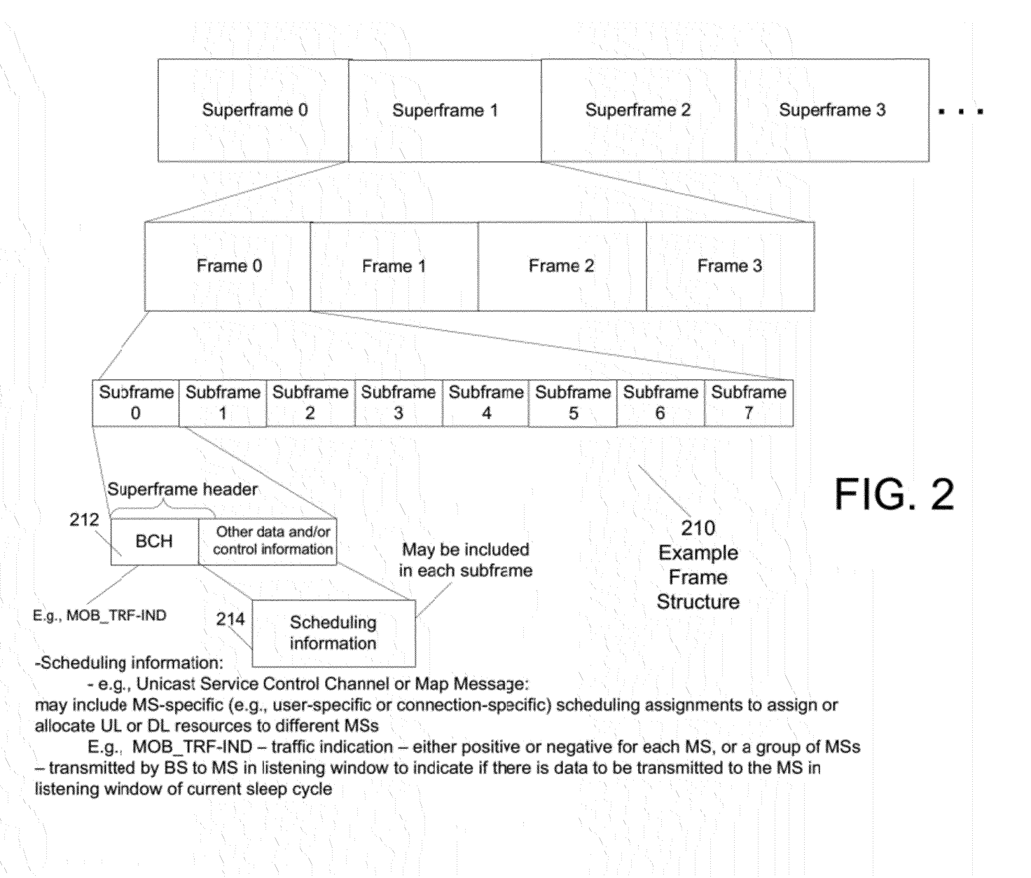

FIG. 2 is a diagram illustrating a frame structure 210 according to an example embodiment. As shown in FIG. 2, several superframes are shown, including superframe 0, superframe 1, superframe 2, superframe 3, . . . . Each superframe may include a number of frames, such as, for example, four frames per superframe. Each frame may include a number of subframes, such as, for example, eight subframes per frame. For example, as shown, frame 1 may include eight subframes, such as subframes 0-7. Thus, according to an example embodiment, a superframe may include 32 subframes, although any number of subframes may be used. Each subframe may include transmission resources, such as, for example, a number of Orthogonal Frequency Division Multiplexing (OFDM) symbols, e.g., across one or more subcarriers. For example, each subframe may include 5-7 OFDM symbols, depending on a type of the subframe. These are merely examples, and a subframe may include any number of resources or OFDM symbols.

Each subframe may be allocated by BS 104 for either DL transmission or UL transmission. The DL/UL ratio for subframes within a frame may vary, based on control information indicated or transmitted by the BS 104. For example, the DL/UL ratio may be 4/4 (meaning, the frame includes 4 DL subframes followed by 4 UL subframes), may be 5/3, or 3/5 or other ratio, depending on the UL and DL traffic in the network. For example, one or more DL subframes may occur first in a frame for the BS 104 to transmit broadcast and unicast information to MSs, followed by one or more UL subframes that may allow one or more of the MSs opportunities or resources to transmit UL to the BS 104.

Referring to FIG. 2 again, the first subframe (subframe 0 in FIG. 2) of each superframe is typically allocated for downlink transmission. Each superframe may include a superframe header (SFH) that is included in the first subframe of the superframe (subframe 0) of the first frame (frame 0) of the superframe. The SFH may include a number of fields, including a broadcast channel (BCH) 212. The BCH 212 may be used by the BS 104 to broadcast to all MSs or provide essential system parameters and system configuration information 214. The BCH 212 may include a primary broadcast channel (PBCH) and a secondary broadcast channel (SBCH). The PBCH may carry deployment wide (or network wide) common information from the BS, while the SBCH may carry sector specific information, where MSs in wireless network 102 may be divided into different sectors. In an example embodiment, the BCH 212 may be frequency division multiplexed with data within the same subframe (subframe 0).

As noted, BCH 212, e.g., provided within a first subframe of a superframe, may include system configuration information 214. System configuration information 214 may include or describe the system configuration of one or more (or each) of the subframes of a superframe. In some cases, the system configuration information 214 may be considered essential for decoding subframes. System configuration information 214 may include, for example, DL/UL ratio for subframes within the superframe (e.g., first 5 subframes are for DL, and last 3 subframes are for UL), subframe concatenation pattern for a superframe, the configuration information of localized resource allocations (LRAs) and distributed resource allocations (DRAs) within a subframe (which may allocate resources for UL or DL transmissions), permutation method for subcarriers, and/or other system configuration information.

As shown in FIG. 2, each subframe may include other data and control information. Although, FIG. 2 only shows the other data and control information for subframe 0, each subframe may include other data and control information.

For example, each subframe may include scheduling information that may schedule, assign or allocate resources to each of the MSs for UL or DL transmissions. The scheduling information in a subframe may allocate or assign resources to a MS for the same subframe, or a future subframe, as examples.

In an example embodiment, the scheduling information may be provided in (or as part of) a unicast service control channel or a Map message. These are merely some examples, and the scheduling information may be provided in a number of different formats, or may be known by different names.

The scheduling information may include, for example, MS-specific (e.g., user-specific or connection-specific) scheduling assignments to assign or allocate UL or DL resources to different MSs. The scheduling assignments may be for unicast transmissions (either uplink or downlink), or DL multicast or broadcast transmissions (e.g., where a MS may be a member of one or more multicast groups).

For example, the MS-specific scheduling information that identifies UL resources for a MS may identify UL resources (e.g., time slot and/or subcarriers or other resources) assigned or allocated to the MS to allow the MS an opportunity to transmit UL to the BS, e.g., in a same or different subframe of the same frame or a next frame, as examples. Similarly, the MS-specific scheduling information that assigns DL resources to a MS may identify resources (e.g., time slot and/or subcarriers) within a current subframe or a future subframe (e.g., next subframe) for which the BS will transmit data to the MS. Thus, during such time period specified by the scheduling assignment or resource allocation, the MS should typically be in a non-sleep (or active) mode or listening window so that the MS may receive the data via the designated resources. Otherwise, if the MS is in sleep window during this period, the BS may transmit data (or other information) to the sleeping MS, and the data or other information may be lost (not received by the MS), for example.

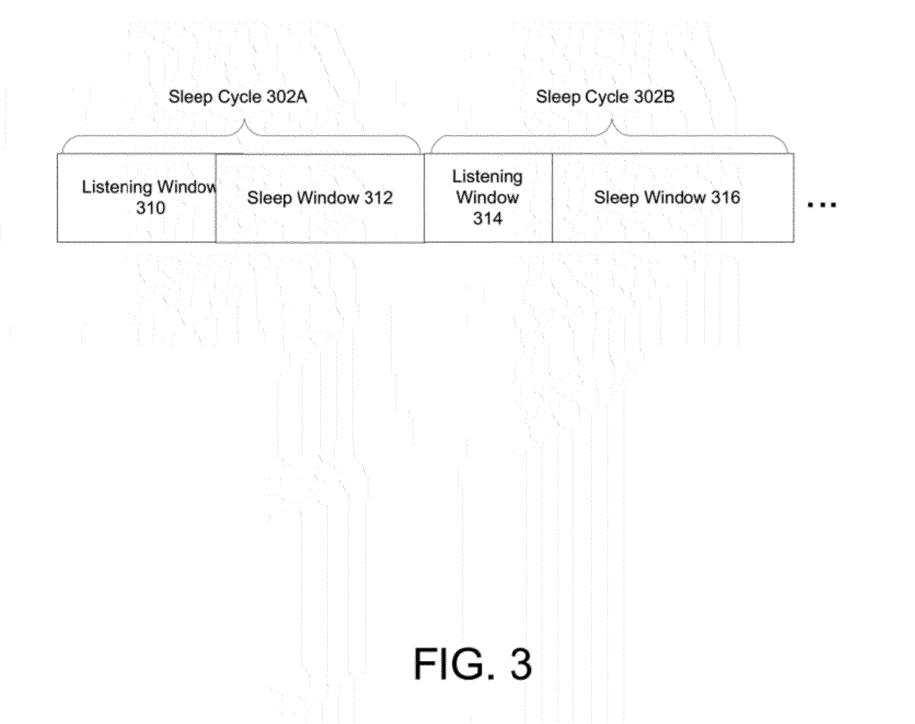

FIG. 3 is a block diagram illustrating operation of a mobile station according to an example embodiment. In an example embodiment, a MS (mobile station) may alternate between a listening window, where the MS may receive data and may transmit data, and a sleep window, where the MS may power down one or more components such that the MS is unable to receive or transmit data, and the BS (base station) typically does not transmit data or other signals to the MS during a sleep mode. A sleep cycle may include a listening window followed by a sleep window, for example. In an example embodiment, each sleep window may be one or more frames, and each listening window may be one or more frames. An initial sleep window size may be, for example, two frames, with one frame for each of the listening window and the sleep window. This is merely an example, and other sizes may be used. The length of each sleep window or listening window may be specified by the BS, or may be negotiated between the MS and BS, as examples. For example, as shown in FIG. 3, a sleep cycle 302A for a MS may include a listening window 310 followed by a sleep window 312. A next sleep cycle 302B for the MS may include a listening window 314 followed by a sleep window 316.

In an example embodiment, referring to FIGS. 2 and 3, a traffic indication (MOB_TRF-IND) may be transmitted by a BS to one or more MSs via the BCH 212 or the scheduling information 214, as examples, or other location in a frame or sub-frame. A traffic indication may be provided for each, or one or more, mobile stations, users, connections, etc. According to an example embodiment, a traffic indication(s) may be transmitted by a BS at the beginning of a listening window (which may typically occur at the beginning of the sleep cycle) to indicate whether or not the BS will transmit data to the MS (or each MS) in the listening window of the current sleep cycle. In an example embodiment, a positive traffic indication for a MS may typically indicate that the BS will be transmitting data to the MS within the listening window of the current sleep cycle, while a negative traffic indication for a MS may typically indicate that the BS will not be transmitting data to the MS in the listening window of the current sleep cycle. Thus, upon receiving a positive traffic indication (e.g., indicating that the BS will be transmitting data to the MS within the listening window of the current sleep cycle), the MS may remain in an active state to receive the data. For example, after transmitting a positive traffic indication for a MS, the BS may transmit a scheduling information or Map information element (Map IE) to identify the location or resources through which the data will be transmitted to the MS, and then the BS will transmit the data to the MS via the indicated resources. Thus, for example, within a first frame of a Listening window, the BS may transmit a traffic indication, followed by a Map IE or other scheduling information and the data (e.g., in the same or a subsequent frame of the listening window of the current sleep cycle) if the traffic indication was a positive traffic indication. While, after a MS receives a negative traffic indication (indicating that the BS will not be transmitting data to the MS within the listening window of the current sleep cycle), the MS may then go into a sleep mode or low power state, until the next listening window. In an example embodiment, in response to receiving a negative traffic indication (and no data) in a listening window, a MS may, for example, increase a size (e.g., double a size) of a next sleep cycle, up to a maximum sleep cycle size (which may typically increase the size of the sleep window of the next sleep cycle). In an example embodiment, in response to receiving a positive traffic indication (and/or data) in a listening window of a current sleep cycle, a MS may reset the size of the next (and/or current) sleep cycle to an initial sleep cycle size.

The traffic indication(s) may be provided in different formats. For example, traffic indications may be provided as a bit map, e.g., with a bit being provided for each MS, where a 1 indicates a positive traffic indication for the MS, and a 0 indicates a negative traffic indication. In another example embodiment, an identifier (e.g., mobile station ID or MSID or other identifier) may be assigned to each MS. Within a specified or known location or transfer identification field or message, the MS may check for the presence of its MSID or identifier. If the MS's MSID is present in the transfer identification message, then this indicates a positive traffic indication for the MS. Whereas, in an example embodiment, an absence of the MS's MSID in the transfer identification message is interpreted or understood by the MS to be a negative traffic indication.

A problem can arise where either a traffic indication is lost or not received by a MS (e.g., where the traffic indication is not received or not decoded correctly by the MS). Where the traffic indication is not received by the MS, the MS does not know whether the lost traffic indication was a positive or negative traffic indication. Thus, among other examples described herein, a number of example embodiments are described to provide techniques to allow a MS and BS to obtain synchronization, or to provide operation that would allow for synchronization between a MS and BS for sleep cycles to continue or be maintained without deactivating the sleep mode.

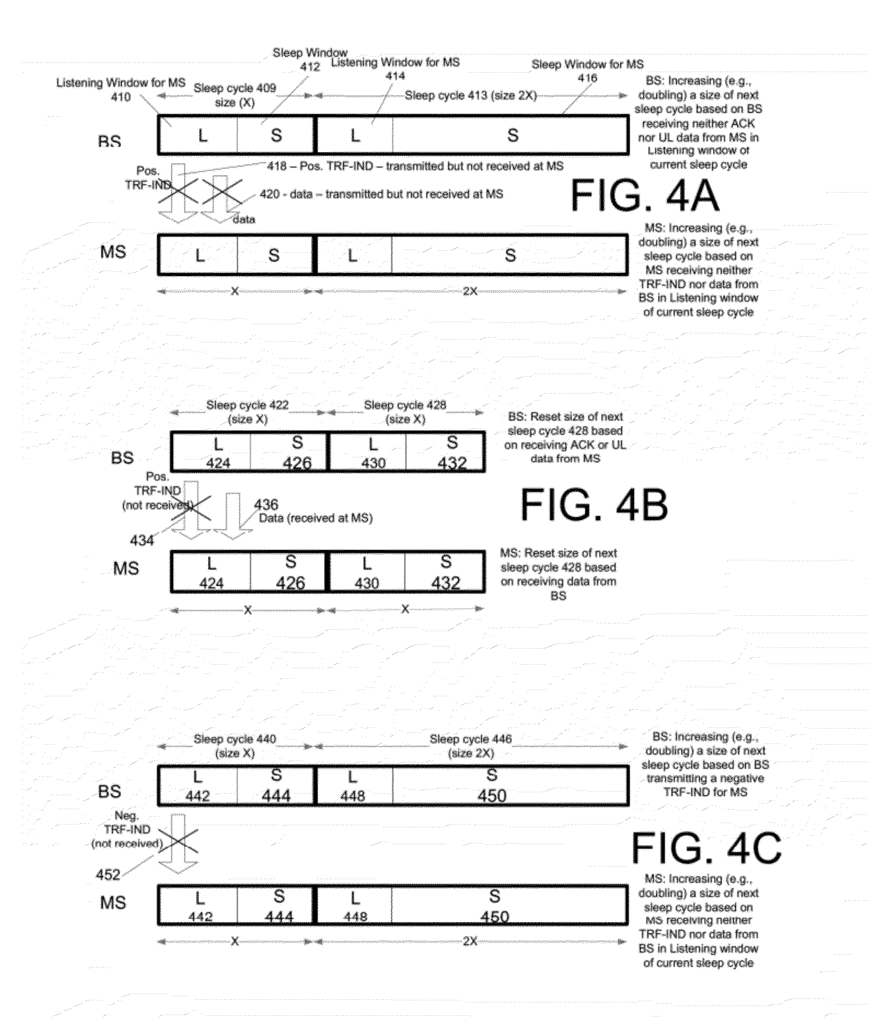

FIG. 4A is a diagram illustrating operation in which a traffic indication and data are transmitted by a base station but not received by a mobile station according to an example embodiment. In this example embodiment, two sleep cycles are shown, including a sleep cycle 409 of size x (e.g., x frames), and a next sleep cycle 413 of size 2x, where x may be 2 frames or any other number. Sleep cycle 409 may include a listening window where the BS may transmit data and signals to the MS, and during which the MS may be expected to receive data and signals from the BS and may transmit data uplink (UL) to the BS. Sleep cycle 409 also includes a sleep window 410 during which BS will not transmit data or other signals to the MS, and the MS may place one or more components in a low power or even an off state, to conserve power. For example, sleep cycle 409 may be provided as an initial sleep window size of 2 frames, with the listening window 410 of one frame, and the sleep window 412 of one frame. Sleep cycle 413 may be double the size of sleep cycle 409, e.g., four frames, including a listening window 414 of one frame, and a sleep window 416 of three frames, as an example.

In operation, BS may transmit a positive traffic indication (Pos. TRF-IND) 418 to the MS (e.g., indicating that one or more packets or MPDUs will be transmitted to the MS during the current listening window 410) and the data 420 or packet (or MPDU). In an example embodiment, data that is received by the MS may typically be acknowledged by the MS transmitting an acknowledgement or ACK back to the BS (or negatively acknowledged by transmitting a NAK), to indicate to the BS that the MS received the transmitted data. However, in this example, both the traffic indication 418 and the data 420 are lost or not received by the MS (e.g., not received or not decoded by the MS). Thus, the MS does not transmit an ACK back to the BS during listening window 410. Also, the MS in this example does not transmit data UL to the BS during listening window 410.

In this example illustrated in FIG. 4A, the MS increases (e.g., doubles) the size of the next sleep cycle 413 (e.g., from two frames to four frames) based on the MS receiving neither the traffic indication 418 nor the data 420 transmitted by the BS (or in response to the MS's failure to receive both the traffic indication 418 and the data 420) during the listening window 410 fo the current sleep cycle 410, to allow the MS to remain in a sleep cycle for a longer period of time during the next sleep cycle 413. Similarly, the BS increases (e.g., doubles) the size of the next sleep cycle 413 because the BS received neither the ACK (of the data) nor UL data from the MS during the listening window 410. Thus, the start and size of the next sleep cycle 413 for both the MS and BS are synchronized or the same even though the traffic indication 418 and data 420 transmitted by the BS for the current sleep cycle 409 have been lost or not received by the MS, and no data ACK/NAK received by the BS during listening window 410.

FIG. 4B is a diagram illustrating operation where a traffic indication and data are transmitted by a base station but the traffic indication is not received by a mobile station according to an example embodiment. In this example, a current sleep cycle 422, including listening window 424 followed by sleep window 426, is followed by a next sleep cycle 428, including a listening window 430 and a sleep window 432.

In the example of FIG. 4B, the BS transmits a positive traffic indication (Pos. TRF-IND) 434 that is not received by the MS. The BS also transmits data 436 or a packet or MPDU 436 that is received by the MS. The MS may send an ACK (not shown) back to the BS to acknowledge receipt of data 436. The BS may reset the size of the next sleep cycle 428 to the initial sleep cycle size based on receiving the ACK (or UL data) from the MS. Similarly, the MS may reset the size of the next sleep cycle 428 to the initial sleep cycle size based on receiving the data 436 from the BS. E.g., since data is being transmitted to from the BS to the MS, the MS will shorten its sleep window for the next sleep cycle 428 to allow greater time/opportunities for the MS to receive signals or data from the BS over the subsequent sleep cycles.

FIG. 4C is a diagram illustrating operation where a negative traffic indication is transmitted by a base station but not received by the mobile station. A current sleep cycle 440, including a listening window 442 and a sleep window 444, is followed by a next sleep cycle 446 that includes a listening window 448 and a sleep window 450. The BS transmits a negative traffic indication (Neg. TRF-IND) 452. However, the negative traffic indication 452 is not received by the MS in the example shown in FIG. 4C. In an example embodiment, the BS increases (e.g., doubles) the size (up to a maximum sleep cycle size) of the next sleep cycle 446 based on the BS transmitting a negative TRF-IND for the MS (e.g., the BS may assume the MS has received the negative traffic indication). The MS may also increase a size of the next sleep cycle 446 (up to a maximum sleep cycle size) based on the MS not receiving a traffic indication nor data from the BS in the listening window 442 of the current sleep cycle 440, for example.

Therefore, with respect to some aspects of the operation of FIGS. 4A-4C, if the traffic indication is lost or otherwise not received by the MS, the MS may assume the (lost) traffic indication was a positive traffic indication and may stay awake for the remainder of the listening window 410 of the current sleep cycle. If the MS does not receive any data during the listening window 410, the MS assumes the (lost) traffic indication was a negative traffic indication, and may double the size (up to a maximum sleep window size) of the next sleep cycle 413. If the MS receives data during the listening window of the current sleep cycle, then the MS may reset the size of the next sleep cycle to the initial sleep cycle size (based on receipt of data), as shown in FIG. 4B. If a negative traffic indication is transmitted by a BS and lost (not received by MS), then both the MS and BS may reset the size of the next sleep cycle to the initial sleep window size.

Although not separately shown in the Figures, another example embodiment, will now be described. According to an example embodiment, when a MS fails to receive a traffic indication or data within a listening window, the MS may assume the (e.g., lost) traffic indication was positive and resets the current sleep cycle and the next sleep cycle to the initial sleep cycle size. The MS will keep or maintain the initial sleep cycle size for sleep cycles until receiving a traffic indication or data from the BS. Also, the MS will reset the current and next sleep cycles to the initial sleep cycle size if the MS receives a positive traffic indication or data from the MS, and then may send an ACK (acknowledging receipt of the data) to the BS. If the MS receives a negative traffic indication, the MS will increase or double the size of the next sleep cycle. In this example embodiment, the BS may similarly increase, e.g., double, the size of the next sleep cycle when it sends a negative traffic indication in the current sleep cycle (and receives no UL data from the MS). The BS may also reset a size of the current sleep cycle and next sleep cycle to the initial sleep cycle size when the BS sends a positive traffic indication (and/or data) to the MS in the listening window of the current sleep cycle.

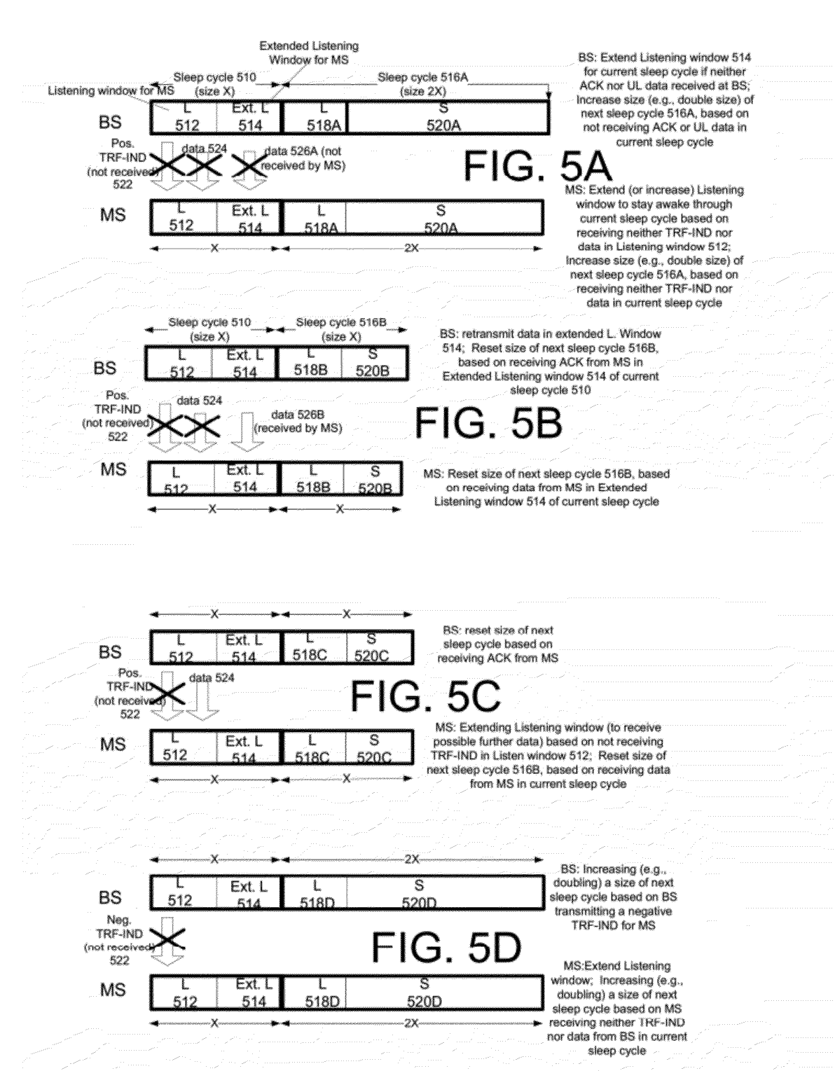

FIG. 5A is a diagram illustrating operation where a traffic indication and data are transmitted but not received by a mobile station and a listening window of the current sleep cycle 510 is extended according to an example embodiment. Referring to FIG. 5A, a current sleep cycle 510, including a listening window 512 and an extended listening window 514 (which may have originally been provided as a sleep window 514), is followed by a next sleep cycle 516A that includes a listening window 518A and a sleep window 520A. A BS transmits a positive traffic indication 522 and a data 524 within the listening window of the current sleep cycle 510. The traffic indication 522 and data 524 are not received by the MS. Since no data is received at the MS, the MS does not send an ACK to the BS during the current sleep cycle 510. Since no ACK or data is received at the BS from the MS during the listening window 512 of the current sleep cycle 510, the BS increases a size of the listening window 512, and may accordingly decrease a size of the sleep window, which may result in or create an extended listening window 514 where the MS may remain in an active state to receive data or signals from the BS, and the BS may retransmit the data to the MS.

Thus, for example, the data 524 is retransmitted at 526A by the BS to the MS during the extended listening window 514 of the current sleep cycle 510, but this data retransmission 526A may not be received by the MS in this example. If the BS still does not receive an ACK or UL data from the MS within the current sleep cycle 510, then the BS will increase or double the size of the next sleep cycle 516A (e.g., double the size of sleep cycle from 2 frames to 4 frames).

The MS may increase or extend the listening window 512, resulting in an extended listening window 514 (e.g., in place of a sleep window), if the MS does not receive the traffic indication 522 nor data 524 from the BS during the listening window 512 of the current sleep cycle 510. This allows the MS to stay awake through, e.g., the entire current sleep cycle since the BS may transmit data or other signals to the MS during this period, or the BS may retransmit data at 526A. If a traffic indication or data is not received during the current sleep cycle (including the listening window 512 and extended listening window), the MS may increase or double the size of the next sleep cycle 516A up to a maximum sleep cycle size.

FIG. 5B is a diagram illustrating operation in which data retransmitted within an extended listening window is received by a mobile station according to an example embodiment. In this example, the retransmitted data 526B from the BS to the MS during the extended listening window 514 is received by the MS. This may cause the MS to send an ACK (acknowledgement) of receipt of the data to the BS.

The MS resets the size of the next sleep cycle 516B to the initial sleep cycle size (e.g., 2 frames) based on receipt of the data by the MS in the extended listening window 514. The BS also resets a size of the next sleep cycle 516B to an initial sleep cycle size based upon receipt of the ACK (acknowledging receipt of the data by the MS) during the extended listening window 514 of the current sleep cycle 510.

FIG. 5C is a diagram illustrating operation where a traffic indication is transmitted and not received and data is transmitted and received by a mobile station according to an example embodiment. In this example, a current sleep cycle is followed by a next sleep cycle that includes a listening window 518C and a sleep window 520C. The BS transmits a positive traffic indication 522 and data 524 during listening window 512 of the current sleep cycle. The traffic indication 522 is lost or otherwise not received by the MS, while the data 524 is received by the MS. The MS may send an ACK or acknowledgement for the data to the BS during the listening window 512 of the current sleep cycle. The BS may reset the size of the next sleep cycle to the initial sleep window size (e.g., reset to 2 frames) based on receipt of the ACK from the MS during the current sleep cycle. Similarly, the MS may extend the listening window to include extended listening window 514 to allow the MS to receive data or other signals from the BS through the entire current sleep cycle, for example, e.g., based on not receiving the traffic indication 522. Also, the MS may reset the size of the next sleep cycle to the initial sleep cycle size based on receipt of data 524 from the BS.

FIG. 5D is a diagram illustrating operation where a negative traffic indication is transmitted but not received by a mobile station according to an example embodiment. As shown in FIG. 5D, a next sleep cycle may include a listening window 518D and a sleep window 520D. The BS transmits a negative traffic indication 522 which is not received by the MS. In an example embodiment, the BS increases, e.g., doubles, the size of the next sleep window based on the BS transmitting a negative traffic indication and not receiving data or signals from the MS during the current sleep cycle. Similarly, the MS may increase, e.g., double, the size of the next sleep cycle based on a failure to receive a traffic indication or data from the BS during the current sleep cycle.

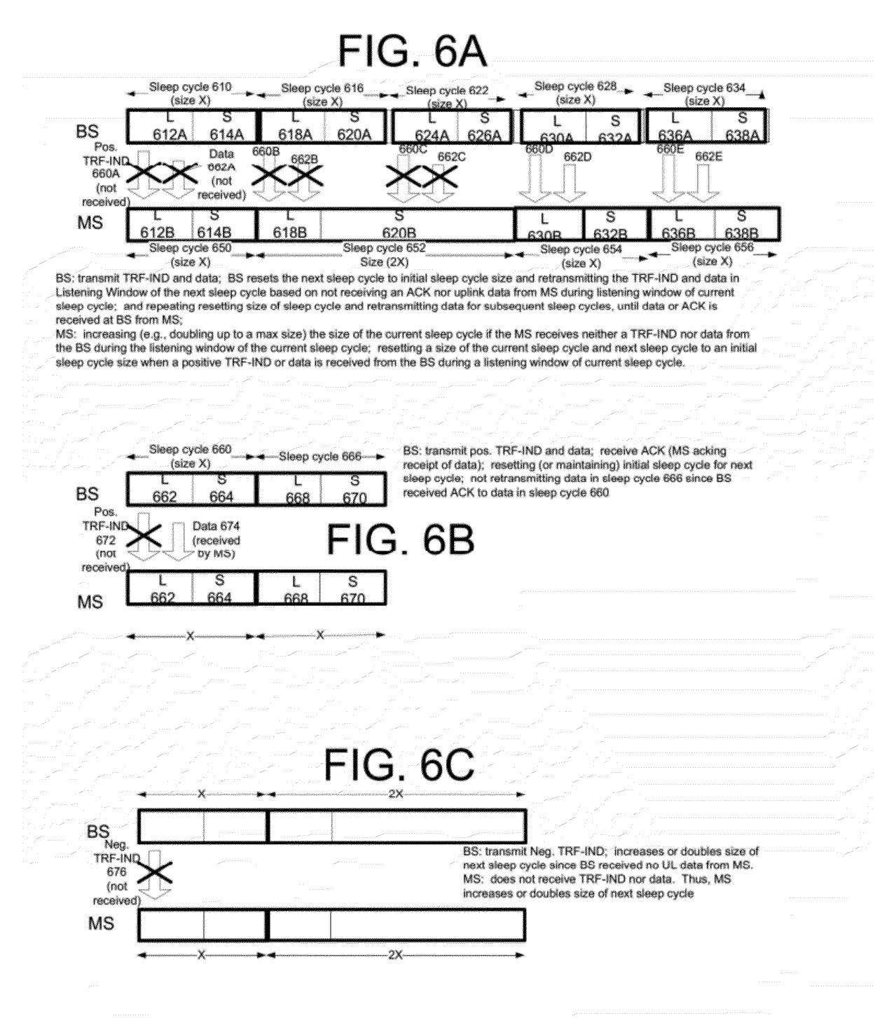

FIG. 6A is a diagram illustrating operation where a mobile station may increase a size of a next sleep cycle if the mobile station does not receive a traffic indication or data during a listening window of the current sleep cycle according to an example embodiment. As shown in FIG. 6A, several sleep cycles are provided from the perspective of the BS, including sleep cycle 610 including listening window 612A and sleep window 614A, sleep cycle 616 including listening window 618A and sleep window 620A, sleep cycle 622A including listening window 624A and sleep window 626A, sleep cycle 628 including listening window 630A and sleep window 632A, and sleep cycle 634 including listening window 636A and sleep window 638A. Each of the sleep cycles 610, 616, 622, 628 and 634 are of size x (e.g., 2 frames in size as an example, which may be the initial sleep cycle size).

In FIG. 6A, several sleep cycles are shown from the MS perspective, including: sleep cycle 650 that includes listening window 612B and sleep window 614B, sleep cycle 652 that includes listening window 618B and sleep window 620B, sleep cycle 654 that includes listening window 630B and sleep window 632B, and sleep cycle 656 that includes listening window 636B and sleep window 638B. Sleep cycles 650, 654 and 656 are of size x (e.g., of size 2 frames, with 1 frame for listening window and 1 frame for sleep window, as an example), and sleep cycle 652 is size 2x (e.g., of size 4 frames, with 1 frame for listening window and 3 frames for sleep window, as an example).

Referring to FIG. 6A, the BS transmits a positive traffic indication 660A and data 662A. However, neither the traffic indication 660A nor the data 662A are received by the MS (both are lost, or not received and decoded by the MS, in this example). The MS does not send an ACK to the BS since the MS did not receive the data 662A. Since the BS has not received an ACK or data from the MS in the current sleep cycle 610, the BS resets the size of the next sleep cycle 616 to the initial sleep cycle size (e.g., 2 frames in size, or x). In this example, the BS also retransmits the traffic indication at 660B and the data at 662B in the listening window 618A of the next sleep cycle 616 if neither the ACK nor UL data are received at the BS from the MS during the listening window 612A of the current sleep cycle 610. The BS, for subsequent sleep cycles, may continue to (or repeatedly) reset a size of the next sleep cycle (e.g., 622, 628, 634, . . . ) to the initial sleep cycle size and retransmit the traffic indication as 660C, 660D, and 660E . . . and retransmit the data as 662C, 662D, and 662E as shown until data or an ACK (or other signal) is received from the MS, for example. Thus, the BS may keep the initial sleep cycle size and retransmit the positive TRF-IND and data for subsequent cycles until an ACK or data is received at the BS from the MS.

Referring to FIG. 6A, with respect to the MS, the MS may reset a size of the current sleep cycle 650 and the next sleep cycle 652 to an initial sleep cycle size when a positive traffic indication or data is received from the base station. For example, sleep cycles 654 and 656 are reset to a size of x frames (e.g., initial sleep cycle size) when traffic indication 660D and/or data 662D are received at the MS during listening window 630A of current sleep cycle 654. Also, if neither the traffic indication nor the data was received at the MS during the listening window of the current sleep cycle (e.g., if both the traffic indication and the data were lost or not received and decoded at MS), the MS may assume the (lost) traffic indication was negative and may increase (e.g., double, up to a maximum sleep cycle size) the size of the current sleep cycle and the next sleep cycle, (provided there was a lost traffic indication). For example, MS may increase, e.g., double, the size of the current sleep cycle 652 (as compared to size of previous sleep cycle 650) since neither the traffic indication 660B nor data 662B were received by MS during listening window 618B of current sleep cycle 652, for example. Sleep cycle 654 would also typically be increased in size, e.g., doubled, based on lost traffic indication 660B and data 662B, however, the received traffic indication 660D and/or data 662D at the MS causes the MS to reset the then current sleep cycle 654 back to the initial sleep cycle size n, as well as reset the next sleep cycle 656. Therefore, according to an example embodiment, a size of a current sleep cycle can change based on what is (or is not) received at the MS (or BS) during the listening window of the current sleep cycle.

FIG. 6B is a diagram illustrating operation in which a size of a current sleep cycle and next sleep cycle may be reset to an initial sleep cycle size based on receipt of data 674 at the MS during a listening window of the current sleep cycle 660. The MS may send an ACK (not shown) to the BS to acknowledge receipt of the data 674 during the listening window 662 of the current sleep cycle 660. Similarly, the BS may transmit a positive traffic indication 672 (which is not received by the MS) and data 674 (which is received by the MS) during a listening window 662 of the current sleep cycle 660. The BS does not retransmit data in next sleep cycle 666 since the BS received an ACK to acknowledge the MS's receipt of the data 674.

FIG. 6C is a diagram illustrating operation in which a negative traffic indication is transmitted by a base station but not received by a mobile station. The BS may increase or double the size of the next sleep cycle if BS did not receive UL data (or other signals) from the MS. The MS in this example does not receive the traffic indication but receives the data. The MS may increase or double a size (e.g., up to a maximum sleep cycle size) of a next sleep cycle based on the MS's failure to receive the traffic indication 676 (and other signals) in the listening window of the current sleep cycle.

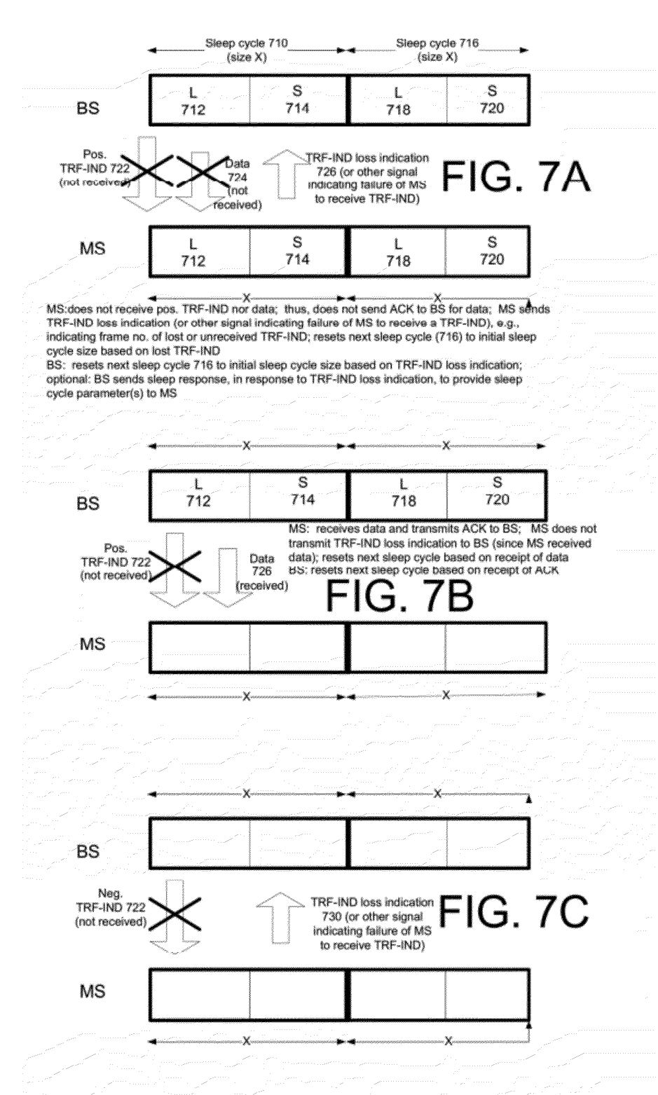

FIG. 7A is a diagram illustrating operation where a mobile station may transmit a signal to a base station indicating a failure of the mobile station to receive a traffic indication. Referring to FIG. 7A, two sleep cycles are shown including a sleep cycle 710 that includes a listening window 712 and a sleep window 714, followed by a sleep cycle 716 that includes a listening window 718 and a sleep window 720. The BS transmits a positive traffic indication 722 and data 724 to the MS. However, the traffic indication 722 and data 724 are lost or not received at the MS during the listening window 712 of the current sleep cycle 710. Because the MS does not receive data from the BS during the listening window 712 of the current sleep cycle 710, the MS does not send an ACK (acknowledgement) to the BS to acknowledge receipt of such data. Rather, the MS transmits or sends to the BS a signal (such as a traffic indication loss indication or TRF-IND loss indication) indicating a failure of the MS to receive a traffic indication during the listening window 712 of the current sleep cycle 710. In an example embodiment, the signal, e.g., TRF-IND loss indication, may include a frame number of the lost TRF-IND 722 or other identification information to identify the TRF-IND that was lost or not received by the MS. In one example embodiment, both the MS and BS may be configured to reset a size of a next sleep cycle 716 to the initial sleep cycle size after transmission (MS) or receipt (BS) of a TRF-IND loss indication. Thus, in the case where a traffic indication is lost or not received, the TRF-IND loss indication signal, sent by the MS to the BS, allows both the MS and BS to know that the TRF-IND was lost and to perform a reset of the sleep cycle size of the next sleep cycle to the initial sleep cycle size, e.g., to continue or maintain sleep cycle synchronization between the MS and BS. Thus, the MS may reset a size (to initial sleep cycle size) of the next sleep cycle 716 after transmission of the TRF-IND loss indication, and the BS may reset a size of the next sleep cycle 716 after receipt of the TRF-IND loss indication from the MS.

In an alternative embodiment, in response to receiving the TRF-IND loss indication, the BS may transmit a sleep response to the MS that provides one or more sleep cycle parameters, such as a frame number or frame offset for a next or subsequent sleep cycle, and the size of the next/subsequent sleep cycle, e.g., to synchronize the sleep cycles of the BS and MS (or maintain synchronization). This alternative embodiment may provide more flexibility for the BS to change the next sleep cycle parameters and communicate those parameters to the MS at the cost of additional overhead (the sleep response message), as compared to both BS and MS simply resetting the next sleep cycle in response to the TRF-IND loss indication.

FIG. 7B is a diagram illustrating operation where a traffic indication is lost and data is received at a mobile station according to an example embodiment. The BS transmits a positive traffic indication 722, which is not received at the MS, and a data 726 which is received by the MS. The MS sends an ACK to acknowledge receipt of data 726. The BS resets a size of the next sleep cycle based on receiving the ACK from the MS. The MS receives the data, but does not transmit the TRF-IND loss indication in this example since the data was received by the MS, for example. The MS also resets a size of the next sleep cycle to the initial sleep cycle size.

FIG. 7C is a diagram illustrating operation in which a negative traffic indication 722 is lost (transmitted, but not received by the MS), and the MS transmits to the BS a traffic indication loss indication to indicate loss (or failure to receive) the traffic indication from the BS.

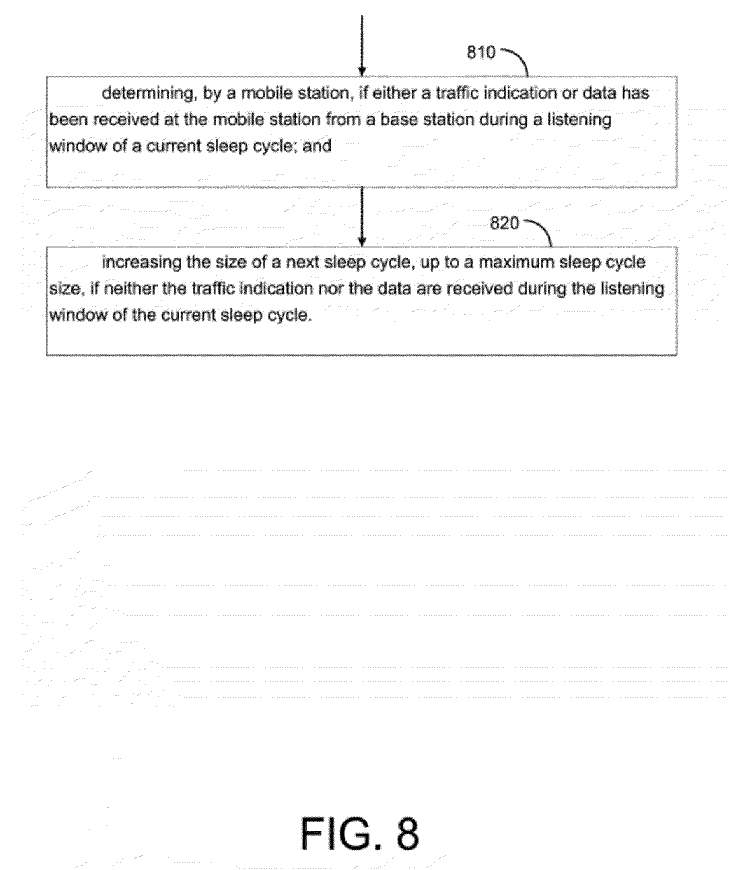

FIG. 8 is a flow chart illustrating operation of a mobile station according to an example embodiment. Operation 810 may include determining (e.g., by processor 1604), by a mobile station, if either a traffic indication or data has been received at the mobile station from a base station during a listening window of a current sleep cycle. Operation 820 may include increasing (e.g., by processor 1604) the size of a next sleep cycle, up to a maximum sleep cycle size, if neither the traffic indication nor the data are received during the listening window of the current sleep cycle.

In an example embodiment, operation 820 may include doubling (e.g., by processor 1604) a size of the next sleep cycle, up to a maximum sleep cycle size, if neither the traffic indication nor the data are received during the listening window of the current sleep cycle.

The flow chart of FIG. 8 may further include determining (e.g., by processor 1604), by the mobile station, if a negative traffic indication has been received at the mobile station during the listening window of the current sleep cycle, and resetting (e.g., by processor 1604) a size of a next sleep cycle to an initial sleep cycle size if the negative traffic indication was received during the listening window of the current sleep cycle.

The flow chart of FIG. 8 may further include increasing (e.g., by processor 1604) a size of the listening window of the current sleep cycle and accordingly decreasing a size of the sleep window of the current sleep cycle if neither the traffic indication nor the data are received at the mobile station during the listening window of the current sleep cycle.

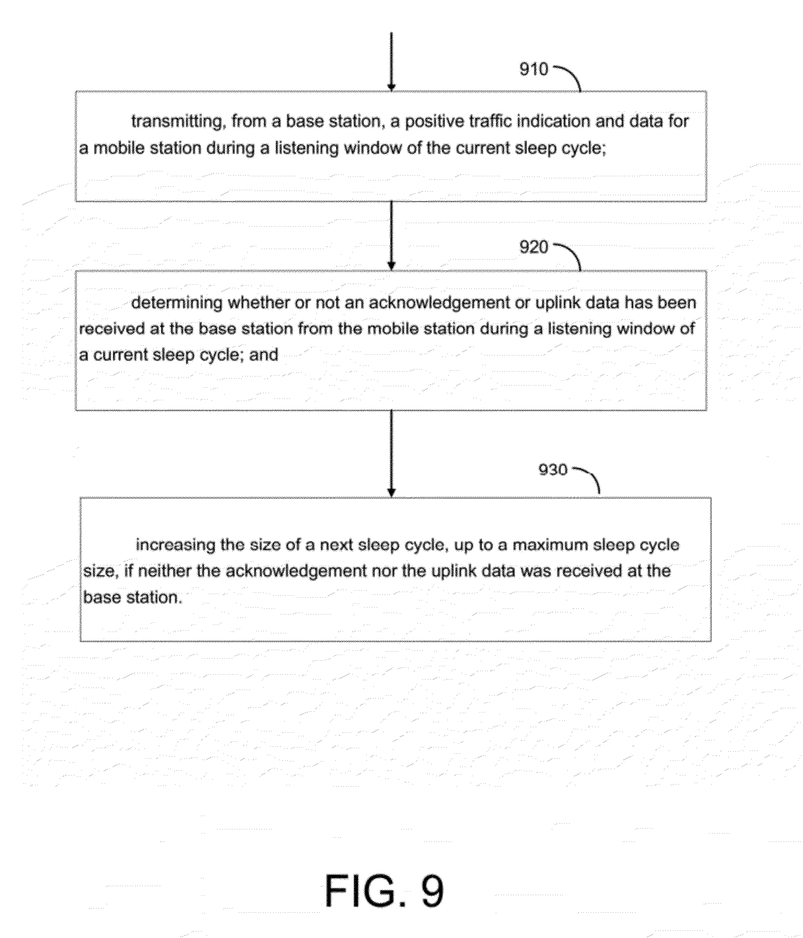

In an example embodiment, operation 820 may include extending the listening window through all or part of the sleep window of the current sleep cycle to allow the mobile station to listen or receive data or signals in an extended listening window of the current sleep cycle. According to another example embodiment, an apparatus may include a processor (e.g., processor 1604). The processor may be configured to determine, by a mobile station, if either a traffic indication or data has been received at the mobile station from a base station during a listening window of a current sleep cycle, and increase the size of a next sleep cycle, up to a maximum sleep cycle size, if neither the traffic indication nor the data are received during the listening window of the current sleep cycle. FIG. 9 is a flow chart illustrating operation of a base station according to an example embodiment. Operation 910 may include transmitting (e.g., by wireless transceiver 1602), from a base station, a positive traffic indication and data for a mobile station during a listening window of the current sleep cycle. Operation 920 may include determining (e.g., by processor 1604) whether or not an acknowledgement or uplink data has been received at the base station from the mobile station during a listening window of a current sleep cycle. And, operation 930 may include increasing (e.g., by processor 1604) the size of a next sleep cycle, up to a maximum sleep cycle size, if neither the acknowledgement nor the uplink data was received at the base station.

In an example embodiment, operation 930 may include doubling the size of the next sleep cycle, up to the maximum sleep cycle size, if neither the acknowledgement nor the uplink data was received at the base station.

In an example embodiment, the flow chart of FIG. 9 may further include performing the following if neither the acknowledgement nor the uplink data was received at the base station: increasing (e.g., by processor 1604) a size of the listening window of the current sleep cycle and accordingly decreasing a size of the sleep window of the current sleep cycle to provide an extended listening window in the current sleep cycle; and retransmitting (e.g., by wireless transceiver 1602), from the base station to the mobile station, the transmitted data one or more times during the extended listening window of the current sleep cycle.

The flow chart of FIG. 9 may further include performing the following if neither the acknowledgement nor the uplink data was received at the base station: retransmitting (e.g., by transceiver 1602) the data one or more times during the sleep window of the current sleep cycle.

According to another example embodiment, an apparatus may include a wireless transceiver (e.g., 1602) configured to transmit, from a base station, a positive traffic indication and data for a mobile station during a listening window of the current sleep cycle; a processor (e.g., 1604) configured to determine whether or not an acknowledgement or uplink data has been received at the base station from the mobile station during a listening window of a current sleep cycle; and, the processor (e.g., 1604) being further configured to increasing (e.g., by processor 1604) the size of a next sleep cycle, up to a maximum sleep cycle size, if neither the acknowledgement nor the uplink data was received at the base station.

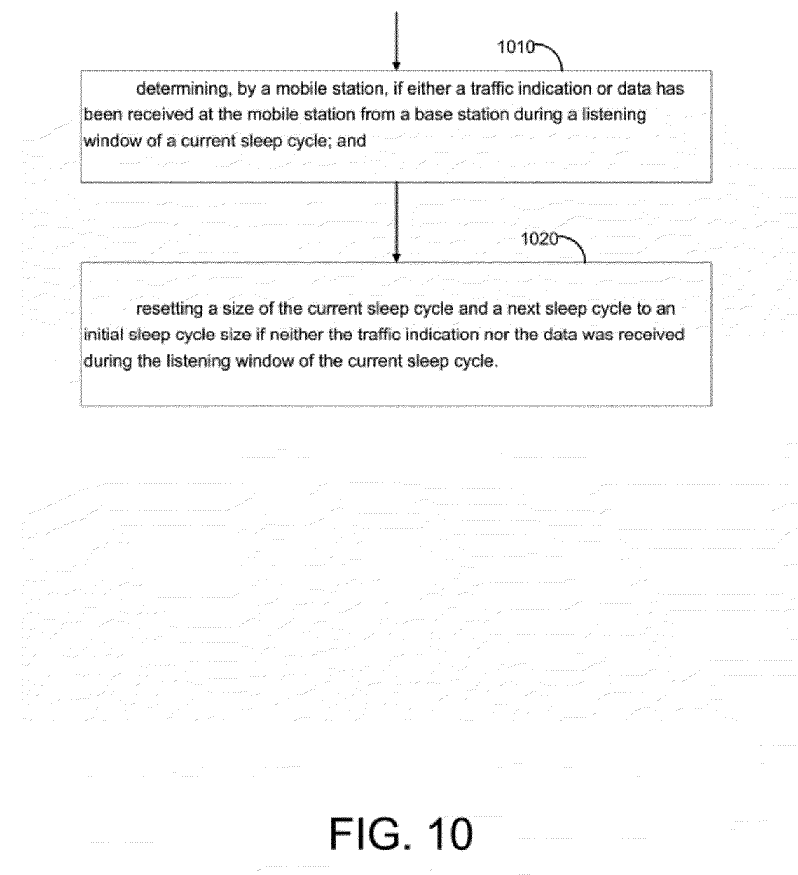

FIG. 10 is a flow chart illustrating operation of a mobile station according to an example embodiment. Operation 1010 may include determining (e.g., by processor 1604), by a mobile station, if either a traffic indication or data has been received at the mobile station from a base station during a listening window of a current sleep cycle; and resetting (e.g., by processor 1604) a size of the current sleep cycle and a next sleep cycle to an initial sleep cycle size if neither the traffic indication nor the data was received during the listening window of the current sleep cycle.

The flow chart of FIG. 10 may further include maintaining (e.g., by processor 1604) the initial sleep cycle size until the mobile station receives either the traffic indication or the data from the base station.

In the flow chart, the maintaining may include maintaining (e.g., by processor 1604) the initial sleep cycle size until the mobile station receives either a positive traffic indication or the data from the base station.

An apparatus may include a processor (e.g., 1604), the processor configured to: determine, by a mobile station, if either a traffic indication or data has been received at the mobile station from a base station during a listening window of a current sleep cycle; and reset a size of the current sleep cycle and a next sleep cycle to an initial sleep cycle size if neither the traffic indication nor the data was received during the listening window of the current sleep cycle.

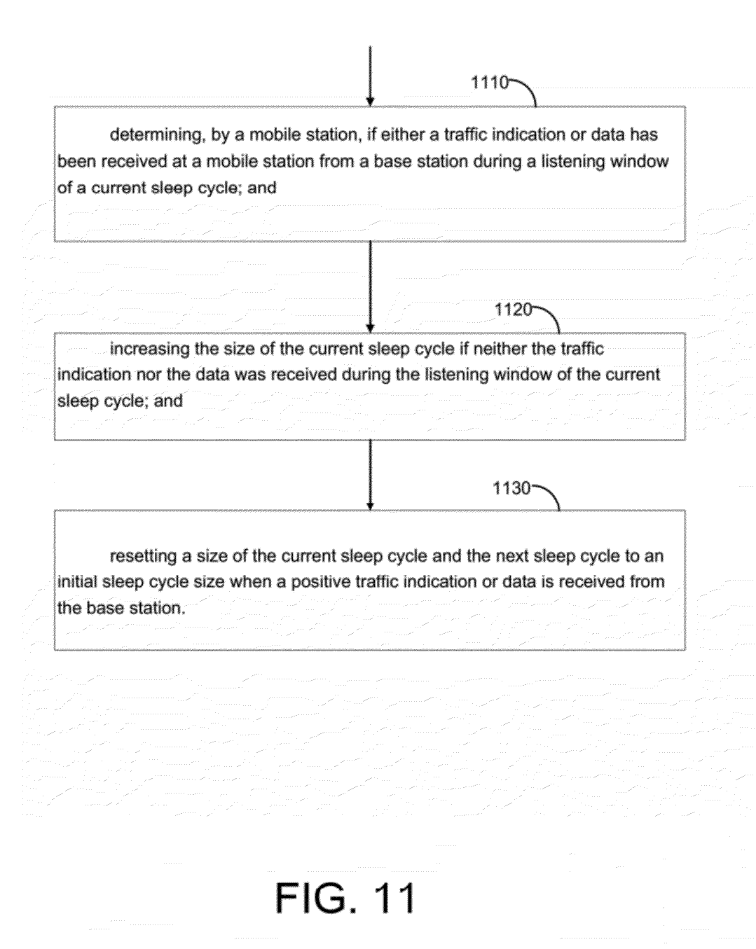

FIG. 11 is a flow chart illustrating operation of a mobile station according to an example embodiment. Operation 1110 may include determining (e.g., by processor 1604), by a mobile station, if either a traffic indication or data has been received at a mobile station from a base station during a listening window of a current sleep cycle. Operation 1120 may include increasing (e.g., by processor 1604) the size of the current sleep cycle if neither the traffic indication nor the data was received during the listening window of the current sleep cycle. And, operation 1130 may include resetting (e.g., by processor 1604) a size of the current sleep cycle and the next sleep cycle to an initial sleep cycle size when a positive traffic indication or data is received from the base station.

In an example embodiment, operation 1120 may include doubling the size (e.g., by processor 1604) of the current sleep cycle, up to a maximum sleep cycle size, if neither the traffic indication nor the data was received during the listening window of the current sleep cycle.

According to an example embodiment, an apparatus may include a processor (e.g., 1604) configured to: determine, by a mobile station, if either a traffic indication or data has been received at a mobile station from a base station during a listening window of a current sleep cycle; increase the size of the current sleep cycle if neither the traffic indication nor the data was received during the listening window of the current sleep cycle; and, reset a size of the current sleep cycle and the next sleep cycle to an initial sleep cycle size when a positive traffic indication or data is received from the base station.

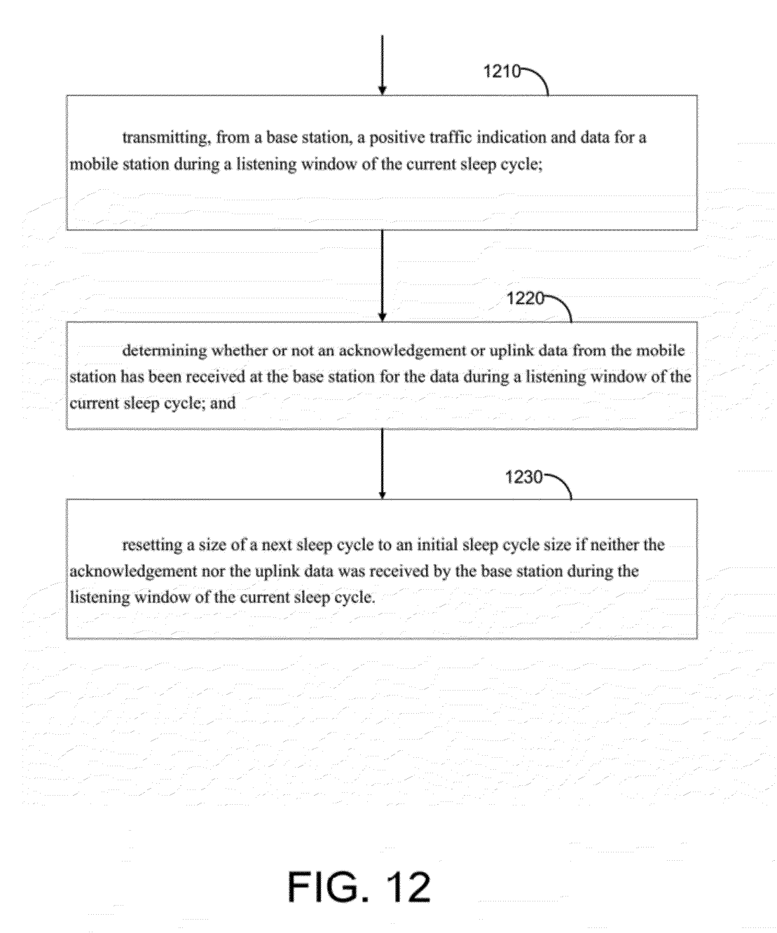

FIG. 12 is a flow chart illustrating operation of a base station according to another example embodiment.

Operation 1210 may include transmitting (e.g., by transceiver 1602), from a base station, a positive traffic indication and data for a mobile station during a listening window of the current sleep cycle. Operation 1220 may include determining (e.g., by processor 1604) whether or not an acknowledgement or uplink data from the mobile station has been received at the base station for the data during a listening window of the current sleep cycle. And, operation 1230 may include resetting (e.g., by processor 1604) a size of a next sleep cycle to an initial sleep cycle size if neither the acknowledgement nor the uplink data was received by the base station during the listening window of the current sleep cycle. The flow chart of FIG. 12 may further include retransmitting (e.g., by transceiver 1602), from the base station to the mobile station, the positive traffic indication and/or data in a listening window of the next sleep cycle if neither the acknowledgement nor the uplink data was received by the base station in the current sleep cycle.

The flow chart of FIG. 12 may further include performing, as necessary, the following one or more times until the base station receives an acknowledgement or an uplink data from the mobile station: resetting (e.g., by processor 1604) a size of a next sleep cycle to an initial sleep cycle if neither the acknowledgement nor the uplink data was received by the base station during the current sleep cycle; and retransmitting (e.g., by transceiver 1602), from the base station to the mobile station, the positive traffic indication and/or data in a listening window of the next sleep cycle if neither the acknowledgement nor the uplink data was received by the base station during the current sleep cycle.

According to another example embodiment, an apparatus may include a wireless transceiver (e.g., 1602) configured to transmit, from a base station, a positive traffic indication and data for a mobile station during a listening window of the current sleep cycle, a processor (e.g., 1604) configured to determine whether or not an acknowledgement or uplink data from the mobile station has been received at the base station for the data during a listening window of the current sleep cycle, and the processor further configured to reset a size of a next sleep cycle to an initial sleep cycle size if neither the acknowledgement nor the uplink data was received by the base station during the listening window of the current sleep cycle.

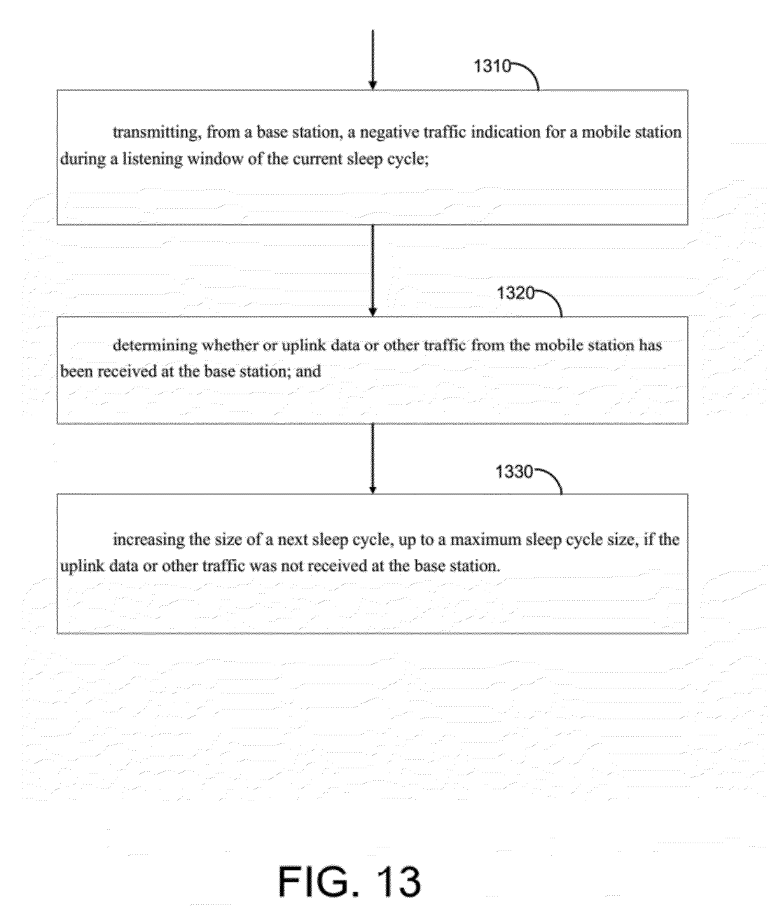

FIG. 13 is a flow chart illustrating operation of a base station according to an example embodiment. Operation 1310 may include transmitting (e.g., by transceiver 1602), from a base station, a negative traffic indication for a mobile station during a listening window of the current sleep cycle. Operation 1320 may include determining (e.g., by processor 1604) whether or uplink data or other traffic from the mobile station has been received at the base station. Operation 1330 may include increasing (e.g., by processor 1604) the size of a next sleep cycle, up to a maximum sleep cycle size, if the uplink data or other traffic was not received at the base station.

In an example embodiment, operation 1330 may include doubling (e.g., by processor 1604) the size of the next sleep cycle, up to a maximum sleep cycle size, if the uplink data or other traffic was not received at the base station.

An apparatus may include a wireless transceiver(e.g., 1602) configured to transmit, from a base station, a negative traffic indication for a mobile station during a listening window of the current sleep cycle, a processor (e.g., 1604) configured to determine whether or uplink data or other traffic from the mobile station has been received at the base station, and wherein the processor is further configured to increase (e.g., double) the size of a next sleep cycle, up to a maximum sleep cycle size, if the uplink data or other traffic was not received at the base station.

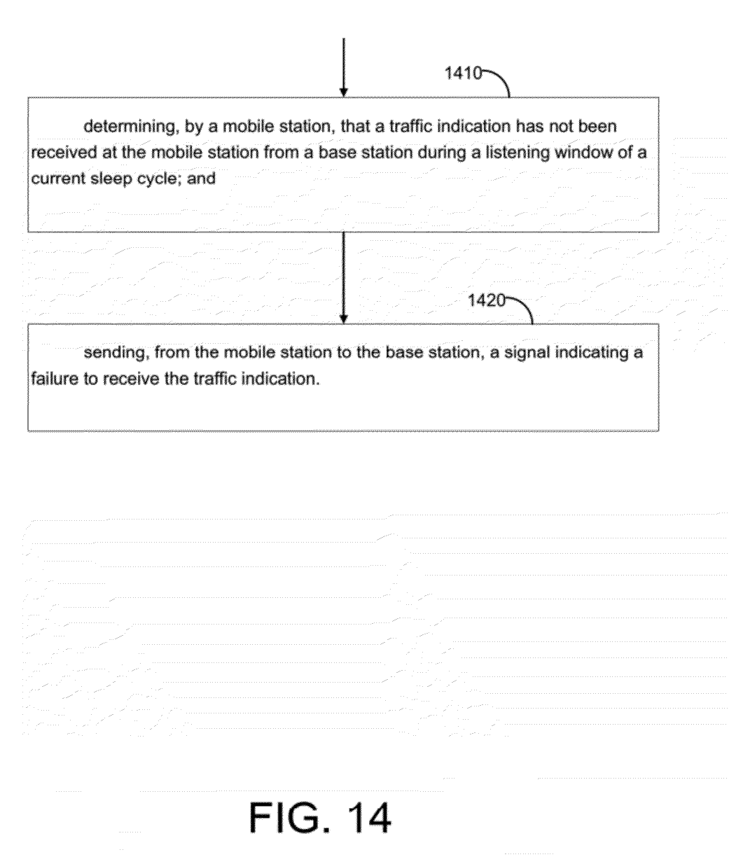

FIG. 14 is a flow chart illustrating operation of a mobile station according to an example embodiment. Operation 1410 may include determining (e.g., by processor 1604), by a mobile station, that a traffic indication has not been received at the mobile station from a base station during a listening window of a current sleep cycle. Operation 1420 may include sending (e.g., by transceiver 1602), from the mobile station to the base station, a signal indicating a failure to receive the traffic indication. The flow chart of FIG. 14 may further include resetting (e.g., by processor 1604) a size of the next sleep cycle to an initial sleep cycle size in response to the determining.

In an example embodiment, operation 1410 may include determining (e.g., by processor 1604), by a mobile station, that neither a traffic indication nor data have been received at the mobile station from a base station during a listening window of a current sleep cycle; and wherein sending comprises sending, from the mobile station to the base station, a signal indicating a failure to receive the traffic indication or data.

In an example embodiment, the flow chart of FIG. 14 may further include receiving (e.g., by transceiver 1602), at the mobile station from the base station, a response indicating one or more sleep cycle parameters to synchronize or resynchronize a sleep cycle of the of the mobile station with the base station.

In an example embodiment, the sleep cycle parameters may include one or more of a sleep cycle start time or frame offset for a next sleep cycle, and/or a size of a next sleep cycle.

According to an example embodiment, an apparatus may include a processor (e.g., processor 1604) configured to determine, by a mobile station, that a traffic indication has not been received at the mobile station from a base station during a listening window of a current sleep cycle, and a transceiver (e.g., transceiver 1602) configured to send or transmit, from the mobile station to the base station, a signal indicating a failure to receive the traffic indication (e.g., TRF-IND loss indication).

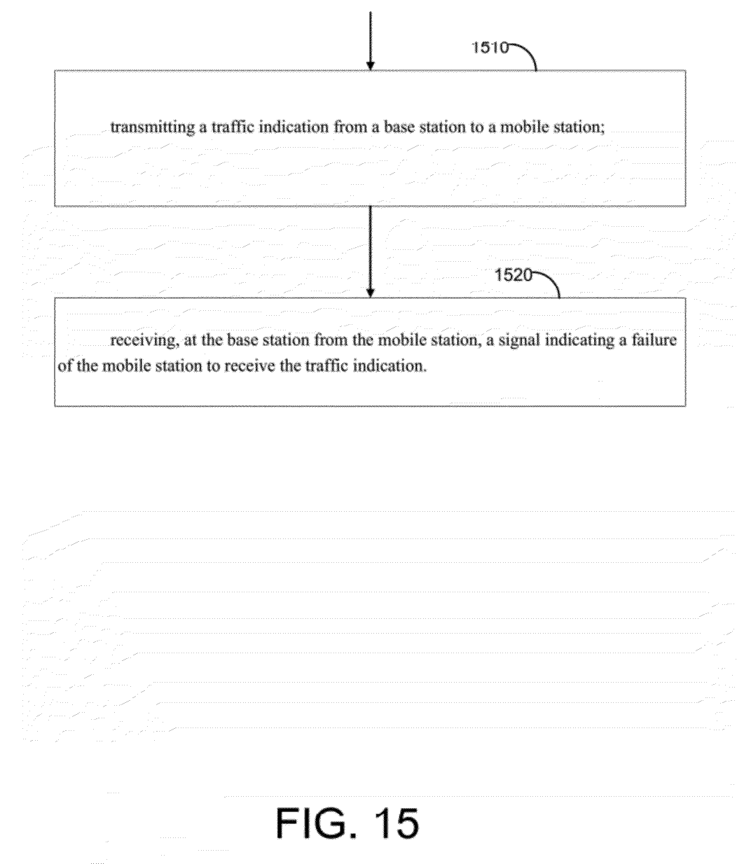

FIG. 15 is a flow chart illustrating operation of a base station according to an example embodiment. Operation 1510 may include transmitting (e.g., by transceiver 1602) a traffic indication from a base station to a mobile station. Operation 1520 may include receiving (e.g., by transceiver 1602), at the base station from the mobile station, a signal indicating a failure of the mobile station to receive the traffic indication.

The flow chart of FIG. 15 may further include resetting (e.g., by processor 1604) a size of the next sleep cycle to an initial sleep cycle size in response to the receiving.

The flow chart of FIG. 15 may further include transmitting (e.g., by transceiver 1602), from the base station to the mobile station, a response to the signal, the response indicating one or more sleep cycle parameters to synchronize or resynchronize a sleep cycle of the of the mobile station with the base station. In an example embodiment, the response may include a start time or frame number or frame offset to identify a sleep cycle, and an indication of a sleep cycle size for the identified sleep cycle.

An apparatus may include a wireless transceiver (e.g., 1602) configured to transmit a traffic indication from a base station to a mobile station, and receive, at the base station from the mobile station, a signal indicating a failure of the mobile station to receive the traffic indication.

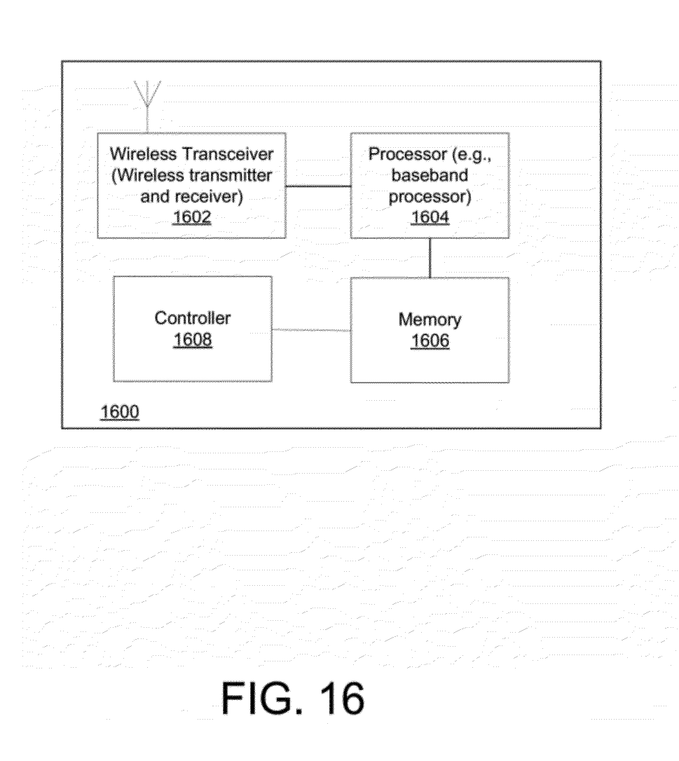

FIG. 16 is a block diagram of a wireless station (or wireless node) 1600 according to an example embodiment. The wireless station 1600 (e.g., base station 104 or mobile station 106) may include, for example, an RF (radio frequency) or wireless transceiver 1602, including a transmitter to transmit signals and a receiver to receive signals, a processor 1604 to execute instructions or software and control transmission and receptions of signals, and a memory 1606 to store data and/or instructions.

Processor 1604 may also make decisions or determinations, generate frames or messages for transmission, decode received frames or messages for further processing, and other tasks or functions described herein. Processor 1604, which may be a baseband processor, for example, may generate messages, packets, frames or other signals for transmission via wireless transceiver 1602. Processor 1604 may control transmission of signals or messages over a wireless network, and may receive signals or messages, etc., via a wireless network (e.g., after being down-converted by wireless transceiver 1602, for example). Processor 1604 may be programmable and capable of executing software or other instructions stored in memory or on other computer media to perform the various tasks and functions described above, such as one or more of the tasks or methods described above. Processor 1604 may be (or may include), for example, hardware, programmable logic, a programmable processor that executes software or firmware, and/or any combination of these. Using other terminology, processor 1604 and transceiver 1602 together may be considered as a wireless transmitter/receiver system, for example.

In addition, referring to FIG. 16, a controller (or processor) 1608 may execute software and instructions, and may provide overall control for the station 1600, and may provide control for other systems not shown in FIG. 16, such as controlling input/output devices (e.g., display, keypad), and/or may execute software for one or more applications that may be provided on wireless station 1600, such as, for example, an email program, audio/video applications, a word processor, a Voice over IP application, or other application or software.

In addition, a storage medium may be provided that includes stored instructions, which when executed by a controller or processor may result in the processor 1604, or other controller or processor, performing one or more of the functions or tasks described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit). Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry. To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1. A method comprising:
determining, by a mobile station, if either a traffic indication or data has been received at the mobile station from a base station during a listening window of a current sleep cycle; and
increasing the size of a next sleep cycle, up to a maximum sleep cycle size, if neither the traffic indication nor the data are received during the listening window of the current sleep cycle.

2. The method of claim 1 wherein the increasing the size of a next sleep cycle comprises doubling a size of the next sleep cycle, up to a maximum sleep cycle size, if neither the traffic indication nor the data are received during the listening window of the current sleep cycle.

3. The method of claim 1 and further comprising:
determining, by the mobile station, if a negative traffic indication has been received at the mobile station during the listening window of the current sleep cycle; and
resetting a size of a next sleep cycle to an initial sleep cycle size if the negative traffic indication was received during the listening window of the current sleep cycle.

4. The method of claim 1 and further comprising increasing a size of the listening window of the current sleep cycle and accordingly decreasing a size of the sleep window of the current sleep cycle if neither the traffic indication nor the data are received at the mobile station during the listening window of the current sleep cycle.

5. The method of claim 4 wherein increasing a size of the listening window the current sleep cycle comprises extending the listening window through all or part of the sleep window of the current sleep cycle to allow the mobile station to listen or receive data or signals in an extended listening window of the current sleep cycle.

6. An apparatus comprising a processor, the processor configured to:
determine, by a mobile station, if either a traffic indication or data has been received at the mobile station from a base station during a listening window of a current sleep cycle; and
increase the size of a next sleep cycle, up to a maximum sleep cycle size, if neither the traffic indication nor the data are received during the listening window of the current sleep cycle.

7. A method comprising:
transmitting, from a base station, a positive traffic indication and data for a mobile station during a listening window of the current sleep cycle;
determining whether or not an acknowledgement or uplink data has been received at the base station from the mobile station during a listening window of a current sleep cycle; and
increasing the size of a next sleep cycle, up to a maximum sleep cycle size, if neither the acknowledgement nor the uplink data was received at the base station.

8. The method of claim 7 wherein the increasing comprises doubling the size of the next sleep cycle, up to the maximum sleep cycle size, if neither the acknowledgement nor the uplink data was received at the base station.

9. The method of claim 7 and further comprising performing the following if neither the acknowledgement nor the uplink data was received at the base station:
increasing a size of the listening window of the current sleep cycle and accordingly decreasing a size of the sleep window of the current sleep cycle to provide an extended listening window in the current sleep cycle; and
retransmitting, from the base station to the mobile station, the transmitted data one or more times during the extended listening window of the current sleep cycle.

10. The method of claim 7 and further comprising performing the following if neither the acknowledgement nor the uplink data was received at the base station:
retransmitting the data one or more times during the sleep window of the current sleep cycle.

11. An apparatus comprising:
a transceiver configured to transmit, from a base station, a positive traffic indication and data for a mobile station during a listening window of the current sleep cycle;
a processor configured to determine whether or not an acknowledgement or uplink data has been received at the base station from the mobile station during a listening window of a current sleep cycle; and
the processor further configured to increase the size of a next sleep cycle, up to a maximum sleep cycle size, if neither the acknowledgement nor the uplink data was received at the base station.

12-36. (canceled)
